(19) United States
(12) Patent Application Publication
(10) Pub. No.: US 2004/0214027 A1
(43) Pub. Date: Oct. 28, 2004

(54) Method for manufacturing laminated leather and manufactured products thereof

(76) Inventor: Jung-Ho Ko, Tainan (TW)

Correspondence Address: BIRCH STEWART KOLASCH & BIRCH, PO BOX 747, FALLS CHURCH, VA, 22040-0747, US

(21) Appl. No.: 10/421,809

(22) Filed: Apr. 24, 2003

(51) Int. Cl. B32B 9/02

(52) U.S. Cl. 428/473; 156/307.5

(57) ABSTRACT

A method for manufacturing laminated leather and manufactured products thereof. First, an oil-based adhesive is applied on the bottom end of the shock-proofing material of the middle layer. Next, the shock-proofing material in the middle layer and the cloth material in the bottom layer will be heated for adhesive bonding at a temperature between 120 and 140 degrees using an upper roller of a roller set for adhesive bonding. Then, a first round of roll pressing for gradual adhesion will be done for 7 to 10 seconds to form a conjoined piece. Further, the oil-based adhesive is applied on the surface of shock-proofing material of middle layer of the conjoined piece. Finally, the middle layer of the conjoined piece and the skin layer on the upper layer will be done a second round of roll pressing for adhesive bonding to form laminated leather.

### FIELD OF THE INVENTION

The invention relates to a method for manufacturing laminated leather and manufactured products thereof and, more particularly, to laminated leather that its middle layer, which is made of breathable and flexible shock-proofing material, is bonded to its base layer, which is made of cloth material, using an upper roller of a roller set having corresponding upper and lower rollers and employing adhesive bonding done by a heating-up; then, a first round of roll pressing for gradual adhesion is performed; afterwards, a skin layer of the upper layer joins in for a second round of roll pressing for adhesive bonding; and finally, the integrally-formed breathable and shock-proofing laminated leather is completed.

### BACKGROUND OF THE INVENTION

The common leather products we often see in daily life such as baseball gloves, shoes, and clothes can be made of genuine leather coming from animal skins. However, genuine leather from animal skins is very limited in quantity supply, and its price is also very expensive. On the other hand, the developments in artificial leather have attempted to solve the problem caused by genuine leather. In fact, continuous research and development made in petrochemical industry has made it possible for the techniques of artificial leather to be continuously improved. Therefore, the supply for leather demand can be kept stable, and various artificial leather products with different structures can then be manufactured according to product requirements.

The above-mentioned artificial leather includes an upper layer located on the top face of artificial leather, looking like the surface of genuine leather. Such artificial leather can be applied to various leather products, such as baseball gloves, common gloves, mountain climbing shoes, clothes, and bags. However, conventional artificial leather cannot have shock-proofing and breathable effects when used for manufacturing leather products. Moreover, most artificial leather is only used as bent portions for leather products, which often results in crinkles on the surface of artificial leather. Therefore, the demand for artificial leather is not high because its application is not broad enough.

### SUMMARY OF THE INVENTION

To cope with the above-mentioned problems, the invention provides a method for manufacturing laminated leather and manufactured products thereof to solve the foregoing technical problems so that artificial leather is able to be breathable and shock proofing. The following are procedures done by the invention. First, an oil-based adhesive is applied on the bottom end of shock-proofing material that is breathable and flexible and located in the middle layer. Second, when the oil-based adhesive appears to be half dried, the shock-proofing material in the middle layer and the cloth material in the bottom layer will be heated for adhesive bonding at a temperature between 120 and 140 degrees by using an upper roller of a roller set, which has corresponding upper and lower rollers. Third, after adhesive bonding, a first round of roll pressing for gradual adhesion will be done for 7 to 10 seconds to form a conjoined piece. Fourth, the oil-based adhesive is applied again on the surface of middle layer of the conjoined piece that contains breathable and flexible shock-proofing material. Fifth, when the oil-based adhesive appears to be half dried, the middle layer of the conjoined piece and the skin layer on the upper layer will be done a second round of roll pressing for adhesive bonding. Finally, the laminated leather of the invention composed of upper, middle, and bottom layers will be combined integrally, and then after cutting and trimming, the laminated leather can be used to manufacture different leather products with shock-proofing and breathable effects. The following are descriptions for specific features and functions of the invention:

1. By providing a middle layer that has breathable, flexible shock-proofing material (such as foaming material, rubber, and foaming resin), the invention can effectively improve the drawbacks of prior artificial leather, which is unable to be breathable and shock proofing.

2. By using an upper roller of a roller set and adhesive bonding done by heating up at a temperature between 120 to 140 degrees, the middle layer of the invention can be bonded to its bottom layer. Then, after the adhesive bonding, a first round of roll pressing for gradual adhesion is performed about 7 to 10 seconds to form a conjoined piece. After that, oil-based adhesive will be applied on the surface of middle layer material of the conjoined piece. Finally, when the oil-based adhesive appears to be half dried, the conjoined piece will be bonded to the skin layer of the upper layer (such as cowhide, pigskin, and sheepskin) through a second round of adhesive bonding to integrally form laminated leather that is breathable and shock proofing.

### BRIEF DESCRIPTION OF THE DRAWINGS

FIG. 1 is a flow chart illustrating the manufacturing process of the invention.

FIG. 2 is a schematic diagram showing that the middle layer and the bottom layer of the invention are to be roll-pressed into a conjoined piece.

FIG. 3 is a schematic diagram showing that the conjoined piece and the upper skin layer of the invention are to be roll-pressed together.

FIG. 4 is a perspective diagram showing distribution of layers of laminated leather of the invention.

FIG. 5 is a sectional view of the laminated leather of the invention.

FIG. 6 is a top view of cutting and trimming the laminated leather of the invention.

FIG. 7 is a schematic diagram showing the invention is applied to a baseball glove.

FIG. 8 is a schematic diagram showing the invention is applied to a shoe vamp.

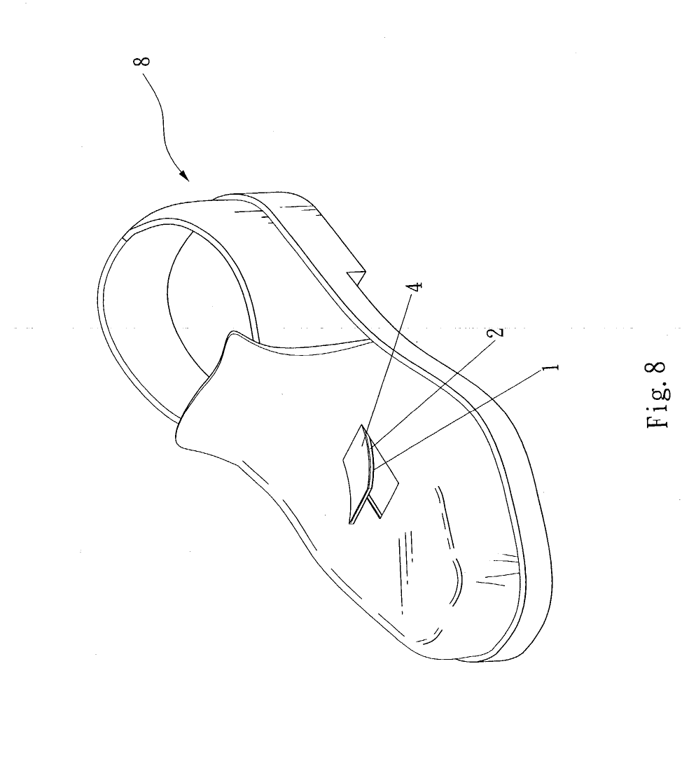

### DETAILED DESCRIPTION OF THE PREFERRED EMBODIMENTS

The objects and technical contents of the invention will be better understood through the description of the following embodiments with reference to the drawings.

First, a technical solution provided by the invention is described as below:

(A) Materials for manufacturing laminated leather include:

1. cloth material of the bottom layer (e.g. fire-proofing cloth or any cloth material that is comfortable and suitable to different requirements)

2. breathable, flexible shock-proofing material of the middle layer (e.g. foaming material or foaming resin)

3. skin layer of the upper layer (e.g. cowhide, pigskin, sheepskin or other leather)

(B) The materials used in the preferred embodiments are listed as below:

| | | First | Second | Third |
|---|---|---|---|---|
| Layers | Elements | Embodiment | Embodiment | Embodiment |
| Bottom | comfortable | cloth | cloth | cloth |
| Layer | cloth material | | | |
| Middle | breathable, | foaming | rubber | foaming |
| Layer | flexible | material | | resin |
| | shock-proofing | | | |
| | material | | | |
| Upper | skin layer | cowhide | sheepskin | pigskin |
| Layer | | | | |

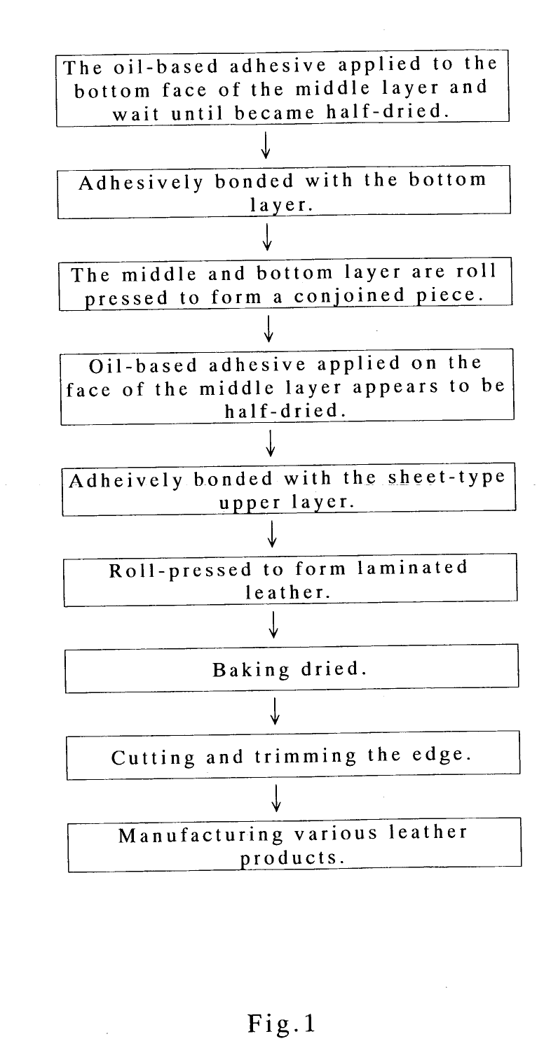

(C) The method for manufacturing the foregoing laminated leather includes the following eight steps with reference to FIG. 1:

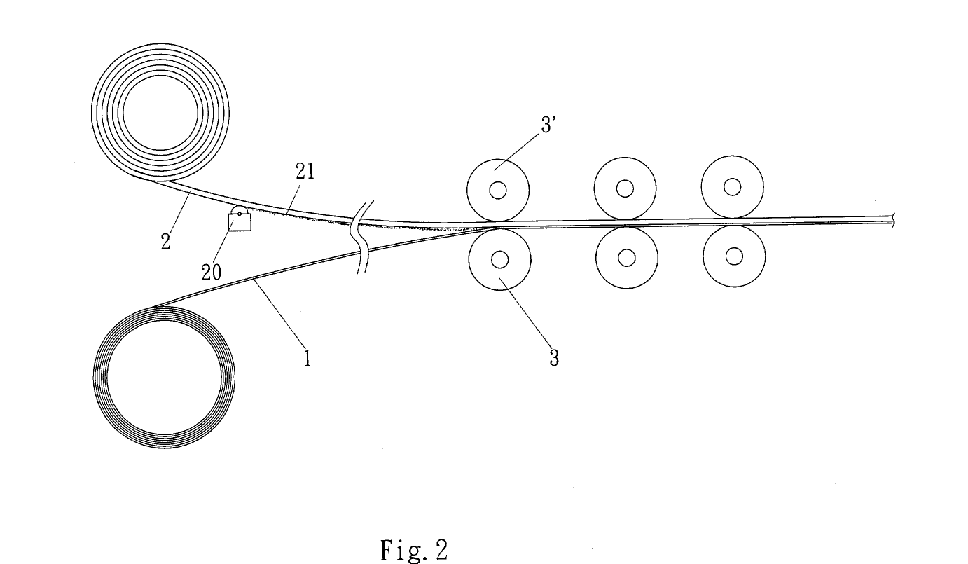

1. The oil-based adhesive 21 is applied to the bottom face of breathable, flexible shock-proofing material 2 of the roll-type middle layer by using the gluing roller wheel 20, as shown in FIG. 2.

2. When the oil-based adhesive 21 on the bottom face of the middle layer appears to be half dried, the middle layer and the roll-type cloth material 1 of the bottom layer will go through the roller set 3 & 3′, as shown in FIG. 2.

3. The middle layer and the bottom layer are adhesive bonded together by the upper roller 3 of the roller set 3 & 3′, wherein the roller set has corresponding upper and lower rollers, through a heating-up at a temperature between 120 and 140 degrees; afterwards, a first round of roll pressing for gradual adhesion is performed on the two layers about 7 to 10 seconds to form a conjoined piece, as shown in FIG. 2.

4. The oil-based adhesive 23 will be applied on the face of breathable, flexible shock-proofing material 2 of the middle layer of the conjoined piece by the gluing roller wheel 22.

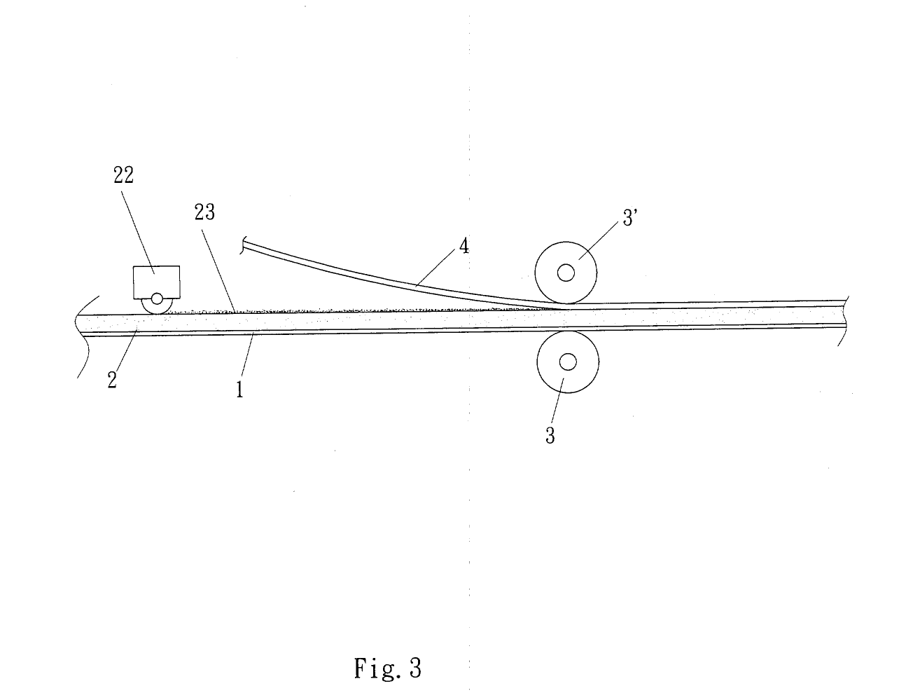

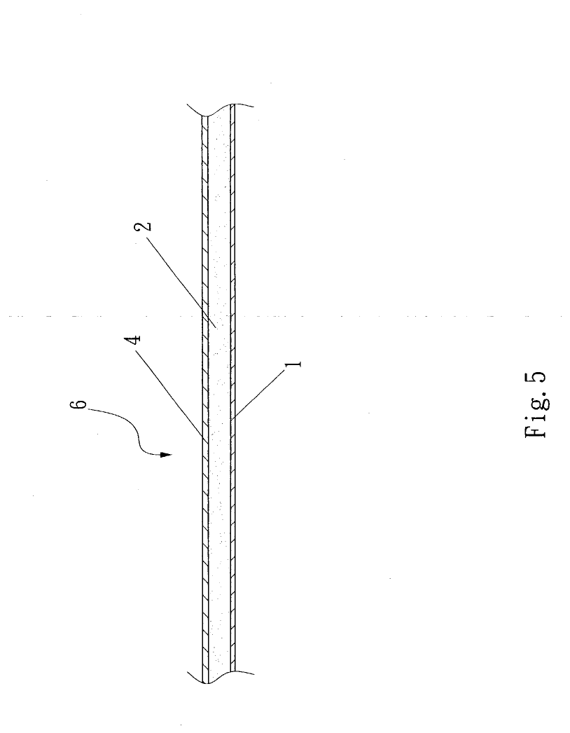

5. When the oil-based adhesive 23 on the face of the middle layer appears to be half dried, the middle layer of the conjoined piece is bonded to the sheet-type skin layer 4, and then a second round of roll pressing for adhesive bonding (as shown in FIGS. 3 & 4) is performed on the two layers to integrally form laminated leather 6 so that its middle layer has breathable, flexible shock-proofing material 2, as shown in FIG. 5.

6. The laminated leather is baking dried to get rid of unwanted moisture vapor and oil-based adhesives 21 & 23.

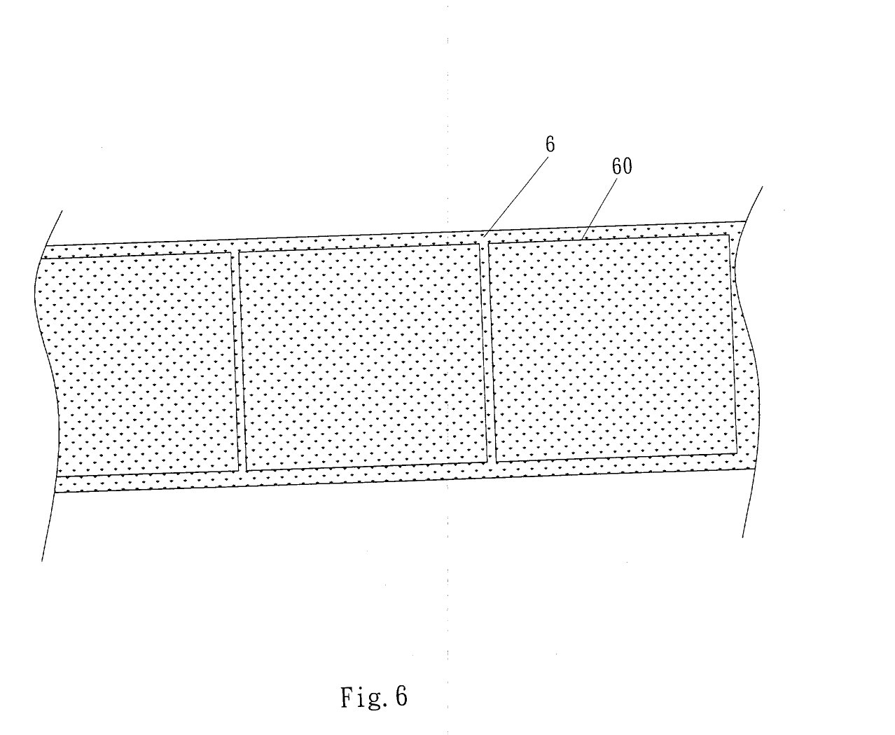

7. Cutting and trimming the edge 60 is done to meet the needed size of laminated leather 6, as shown in FIG. 6.

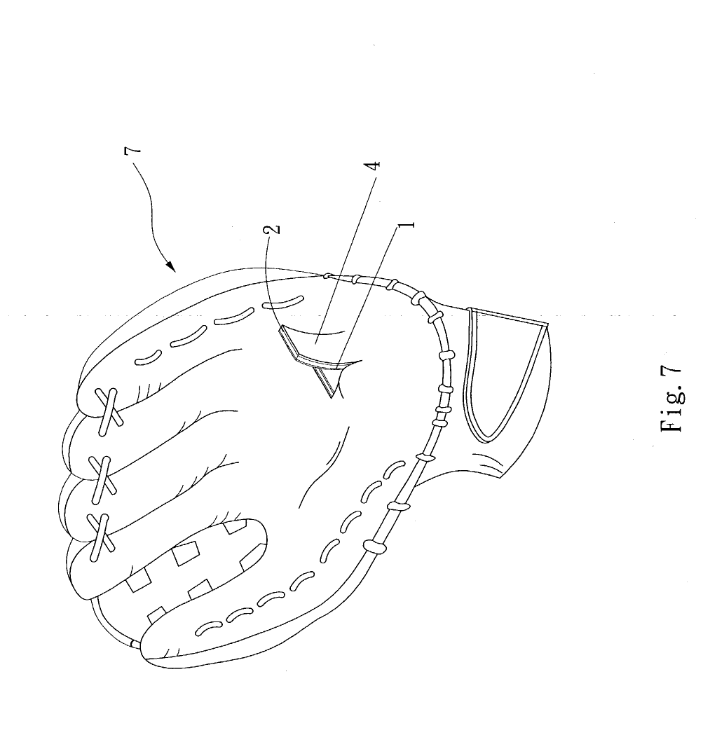

8. Various leather products can be manufactured from the finish-cutting laminated leather according to different requirements. Referring to FIGS. 7 & 8, the invention utilizes a baseball glove and a shoe vamp as examples of leather products.

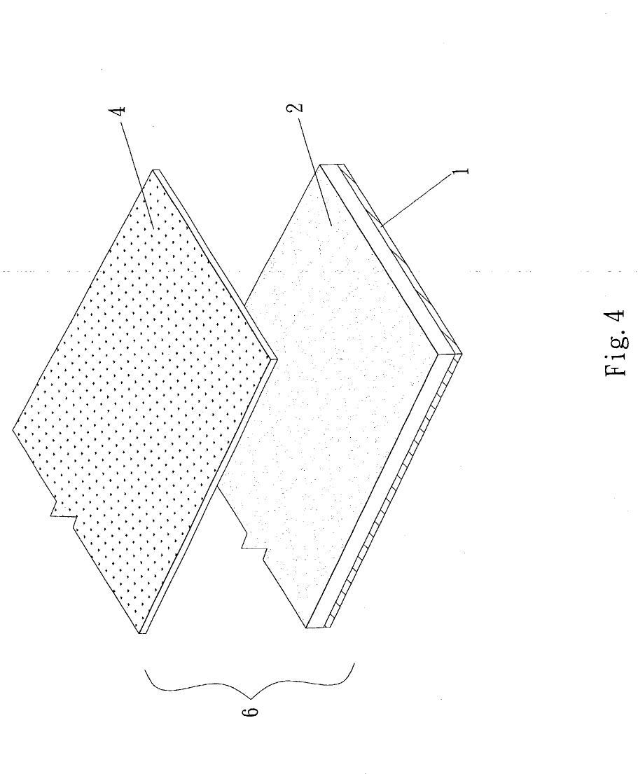

Referring to FIGS. 2 to 6, leather structure that is designed for manufacturing laminated leather 6 using the foregoing materials that are breathable and shock proofing can be applied to all kinds of leather products, such as baseball glove 7 and shoe vamp 8 as shown in FIGS. 7 & 8. Therefore, the problems of the prior leather materials that are unable to be breathable and shock proofing can be solved. Owing to the improvement, the invention will not be limited to the use of bent portions only, and the surface of leather will not have crinkles easily. Hence, the quality of leather product can be enhanced, and the economic value of laminated leather products can be increased as well.

To be concluded, the invention utilizes a cloth material and a shock-proofing material and then performs a first round of roll pressing for gradual adhesion. After that, a skin layer joins in for a second round of roll pressing for adhesive bonding to integrally form laminated leather. The invention does not require complicated procedures for manufacturing artificial leather, and the laminated leather of the invention can be breathable and shock proofing.

What is claimed is:

1. A method for manufacturing laminated leather, including the following steps:
(a) The oil-based adhesive is applied to the bottom face of breathable, flexible shock-proofing material of the roll-type middle layer by using the gluing roller wheel, as shown in FIG. 2.
(b) When the oil-based adhesive on the bottom face of the middle layer appears to be half dried, the middle layer and the roll-type cloth material of the bottom layer will go through the roller set, as shown in FIG. 2.
(c) The middle layer and the bottom layer are adhesive bonded together by the upper roller of the roller set, wherein the roller set has corresponding upper and lower rollers through a heating-up at a temperature between 120 and 140 degrees; afterwards, a first round of roll pressing for gradual adhesion is performed on the two layers about 7 to 10 seconds to form a conjoined piece, as shown in FIG. 2.
(d) The oil-based adhesive will be applied on the face of breathable, flexible shock-proofing material of the middle layer of the conjoined piece by the gluing roller wheel.
(e) When the oil-based adhesive on the face of the middle layer appears to be half dried, the middle layer of the conjoined piece is bonded to the sheet-type skin layer, and then a second round of roll pressing for adhesive bonding (as shown in FIGS. 3 & 4) is performed on the two layers to integrally form laminated leather so that its middle layer has breathable, flexible shock-proofing material, as shown in FIG. 5.
(f) The laminated leather is baking dried to get rid of unwanted moisture vapor and oil-based adhesives.
(g) Cutting and trimming the edge is done to meet the needed size of laminated leather, as shown in FIG. 6.
(h) Various leather products can be manufactured from the finish-cutting laminated leather according to different requirements. Referring to FIGS. 7 & 8, the invention utilizes a baseball glove and a shoe vamp as examples of leather products.

2. Materials for manufacturing laminated leather, including a cloth material of the bottom layer, a skin layer of the upper layer, and a breathable, flexible shock-proofing material of the middle layer; besides, the three layers are integrally bonded.

3. The materials for manufacturing laminated leather as claimed in claim 2, wherein the cloth material can be any kind of comfortable cloth or fireproofing cloth.

4. The materials for manufacturing laminated leather as claimed in claim 2, wherein the shock-proofing material can be any kind of foaming material, rubber, or foaming resin.

5. The materials for manufacturing laminated leather as claimed in claim 2, wherein the skin layer can be any kind of cowhide, sheepskin, pigskin, or other leather.
